(19) United States
(12) Patent Application Publication
(10) Pub. No.: US 2024/0317970 A1
(43) Pub. Date: Sep. 26, 2024

(54) POLYIMIDE FILM FOR GRAPHITE SHEET AND GRAPHITE SHEET PREPARED THEREFROM

(71) Applicant: PI ADVANCED MATERIALS CO., LTD., Chungcheongbuk-do (KR)

(72) Inventors: Hyeong-Seop JUNG, Chungcheongnam-do (KR); Dong-Young WON, Seoul (KR)

(21) Appl. No.: 18/282,863

(22) PCT Filed: Mar. 22, 2022
(86) PCT No.: PCT/KR2022/003935

§ 371 Date: Sep. 19, 2023

(30) Foreign Application Priority Data
Mar. 23, 2021 (KR) 10-2021-0037136

(51) Int. Cl. C08K 5/521; C01B 32/205; C08J 5/18; C08K 5/50

(52) U.S. Cl. CPC C08K 5/521; C01B 32/205; C08J 5/18; C08K 5/50; C01P 2006/32; C08J 2379/08

(57) ABSTRACT

Disclosed is a polyimide film comprising a first plasticizer and a second plasticizer, wherein the molecular weights of the first plasticizer and the second plasticizer are 700 g/mol or less. In addition, a method for manufacturing a graphite sheet using the polyimide film and a graphite sheet having an excellent appearance prepared therefrom are disclosed.

### TECHNICAL FIELD

The present disclosure relates to a polyimide film for graphite sheet and a graphite sheet manufactured therefrom.

### BACKGROUND ART

Recently, electronic devices have become lighter, smaller, thinner, and highly integrated, so a great deal of heat is thus generated in the electronic device. Such heat may shorten the lifespan of products or may cause failure, malfunction, and the like. Therefore, heat control in electronic devices is coming to the fore as an important issue.

A graphite sheet has a higher thermal conductivity than a metal sheet such as copper, aluminum, or the like, thus attracting attention as a heat dissipation member for electronic devices.

Graphite sheets may be manufactured by a variety of methods. For example, a graphite sheet may be manufactured by carbonizing and graphitizing a polymer film. In particular, polyimide films are in the limelight as polymer films for manufacturing graphite sheets due to excellent mechanical and thermal dimensional stability, chemical stability, and the like.

Various additives are available in polyimide films used for manufacturing graphite sheets. Of all these additives, plasticizers are commonly used to improve the physical properties of polyimide films. However, when converting a polyimide film containing a plasticizer, into a graphite sheet, problems of a decrease in thermal diffusivity, deterioration in appearance quality, and the like occur. Thus, solutions to such problems are required.

In addition, depending on the types of plasticizer used, a solution to the problem of an increase in mass loss rate during carbonization and graphitization for manufacturing graphite sheets is also required to be sought.

### DOCUMENT OF RELATED ART

### Patent Document

(Patent Document 1) Korean Patent Application Publication No. 2017-0049912

### DISCLOSURE

### Technical Problem

An objective of the present disclosure is to provide a polyimide film containing a first plasticizer and a second plasticizer, in which a decrease in thermal diffusivity and deterioration in appearance quality are prevented even when being converted into a graphite sheet, and a mass loss rate is low during carbonization and graphitization.

Another objective of the present disclosure is to provide a method of manufacturing a graphite sheet from the polyimide film and a graphite sheet with excellent quality manufactured thereby.

### Technical Solution

To accomplish the objectives described above, in one embodiment of the present disclosure, a polyimide film containing a first plasticizer and a second plasticizer,
in which each of the first plasticizer and the second plasticizer has a molecular weight of 700 g/mol or less,
is provided.

In another embodiment of the present disclosure, a method of manufacturing a graphite sheet, which includes subjecting the polyimide film to carbonization, graphitization, or both of the carbonization and graphitization,
is provided.

In a further embodiment of the present disclosure, a graphite sheet manufactured by the method described above is provided.

### Advantageous Effects

The present disclosure can provide a polyimide film having a low mass rate during carbonization and graphitization, in which a thermal diffusivity is kept from decreasing, a method of manufacturing a graphite sheet from the polyimide film, and a graphite sheet having an excellent appearance manufactured thereby.

### DESCRIPTION OF DRAWINGS

FIG. 1 is a graph showing measured values of the elongation and strength of polyimide films manufactured according to examples and comparative examples of the present disclosure;

FIG. 2 is a graph showing measured values of the true density of polyimide films manufactured according to examples and comparative examples of the present disclosure;

FIG. 3 is a graph showing measured values of the thermal decomposition characteristics of polyimide films manufactured according to examples and comparative examples of the present disclosure; and

FIG. 4 is a graph showing measured values of the thermal diffusivity and foaming thickness of graphite sheets manufactured according to examples and comparative examples of the present disclosure.

### BEST MODE

Hereinafter, preferred embodiments and examples of the present disclosure will be described in detail to such an extent that those skilled in the art can easily implement the technical spirit of the present disclosure. However, the present disclosure may be embodied in many different forms and is not limited to the embodiments and examples set forth herein. Unless the context clearly indicates otherwise, it will be further understood that the terms “comprises”, “comprising”, “includes”, and/or “including”, when used herein, specify the presence of other elements, but do not preclude the presence or addition of other elements.

As used herein, the singular forms are intended to include the plural forms as well, unless the context clearly indicates otherwise.

In interpreting the components, even if there is no separate explicit description, it is interpreted as including the error range.

As used herein to represent a numerical range, the expression “a to b” means “≥a and ≤b”.

A polyimide film, according to one aspect of the present disclosure, contains a first plasticizer and a second plasticizer, in which each of the first plasticizer and the second plasticizer may have a molecular weight of 700 g/mol or less.

For example, each of the first plasticizer and the second plasticizer may have a molecular weight of 700 g/mol or less, 600 g/mol or less, 500 g/mol or less, 450 g/mol or less, 400 g/mol or less, or 370 g/mol or less, but is not limited thereto.

Typically, a plasticizer increases the distance between polyimide polymers, thereby weakening attraction between the polymer chains, and shows an effect of shifting the glass transition temperature (Tg) to a low-temperature region.

When the plasticizer contained in the polyimide film has a molecular weight exceeding 700 g/mol, there was a problem of a decrease in the thermal diffusivity of a graphite sheet when converting the polyimide film into the graphite sheet.

Such a decrease in thermal diffusivity is presumed to be a phenomenon that occurs because the higher the molecular weight of the plasticizer, the further the distance between the polyimide molecular chains of the polyimide film, thereby affecting the graphite sheet manufactured from the polyimide film.

In addition, when the plasticizer in the polyimide film has a molecular weight of less than 250 g/mol, a mass loss rate increases during carbonization and graphitization of the polyimide film for manufacturing the graphite sheet.

Such a change in mass loss rate is presumed to be a phenomenon that occurs because the lower the molecular weight of the plasticizer, the weaker the attraction between the plasticizer molecules or between the plasticizer and the polyimide molecules, and the higher the volatility, thereby failing to perform a role as a plasticizer in the film during carbonization and graphitization of the polyimide film for manufacturing the graphite sheet.

In other words, when the polyimide film contains only one type of plasticizer, both problems of a decrease in the thermal diffusivity and a high mass loss rate may fail to be solved. However, when the polyimide film contains two or more types of plasticizers that differ in molecular weight, the types and ratio of plasticizers may be appropriately adjusted, so both high thermal diffusivity during graphite conversion and low mass loss rate during carbonization and graphitization of the polyimide film are obtainable.

In one embodiment, a difference in molecular weight between the first plasticizer and the second plasticizer may be 150 g/mol or less.

For example, the difference in molecular weight between the first plasticizer and the second plasticizer may be 150 g/mol or less, 120 g/mol or less, 100 g/mol or less, or 50 g/mol or less, but is not limited thereto.

In one embodiment, the first and second plasticizers may be contained in an amount of 1.65% by weight or less with respect to the total amount of an imidization catalyst contained in the polyimide film.

In other words, assuming that the total amount of the imidization catalyst contained in the polyimide film is 100% by weight, the first and second plasticizers may be contained in the polyimide film in a total amount of 1.65% by weight or less.

For example, the first and second plasticizers are contained in the polyimide film in a total amount of 1.65% by weight or less, 1.1% by weight or less, or 0.7% by weight or less.

The imidization catalyst serves to promote a ring closure reaction of polyamic acid, and examples thereof may include aliphatic tertiary amines, aromatic tertiary amines, heterocyclic tertiary amines, and the like. Of all these, heterocyclic tertiary amines may be used in terms of reactivity when used as the catalyst.

Examples of heterocyclic tertiary amines include quinoline, isoquinoline, (3-picoline, pyridine, and the like, which may be used alone or in combination of two or more. The imidization catalyst (for example, 0.2 to 2 moles) may be added in an amount in a range of 0.05 to 3 moles with respect to 1 mole of an amic acid group in the polyamic acid. Within the above range, sufficient imidization is performed, and casting in a film form may be beneficial, but the present disclosure is not limited thereto.

When the first and second plasticizers are contained in the total amount exceeding 1.65% by weight, the thermal diffusivity decreases and the foaming rate increases when being converted into the graphite sheet.

In addition, with the increasing amount of the plasticizers, the density decreases when being converted into the polyimide film and the graphite sheet.

In one embodiment, a weight ratio of the first plasticizer to the second plasticizer may be in a range of 1:9 to 9:1.

With the increasing proportion of the plasticizer having a relatively high molecular weight in the total amount of the plasticizers (amount of the first plasticizer+amount of the second plasticizer), a tendency that the thermal diffusivity of the graphite sheet decreases, and the foaming rate (foam thickness) increases is shown.

In addition, with the increasing proportion of the plasticizer having a relatively high molecular weight in the total amount of the plasticizers (amount of the first plasticizer+amount of the second plasticizer), a tendency that the densities of the polyimide film and the graphite sheet increase and then decrease is shown.

As the weight ratio of the plasticizer having a relatively high molecular weight to the plasticizer having a relatively low molecular weight in the total amount of the plasticizers is adjusted, the thermal diffusivity, foaming rate, and true density of the graphite sheet may be appropriately controlled.

In one embodiment, each of the first plasticizer and the second plasticizer may be a phosphorus (P)-based plasticizer. The phosphorus (P)-based plasticizer may also exhibit the characteristics of a flame retardant.

In one embodiment, the first plasticizer or the second plasticizer may be any one selected from the group consisting of triphenyl phosphate, tricresyl phosphate, triphenylphosphine, resorcinol bis(diphenyl phosphate), and bisphenol A bis(diphenyl phosphate).

In one embodiment, the polyimide film may be manufactured by imidizing polyamic acid formed by reacting a dianhydride monomer and a diamine monomer, in which the polyamic acid has a weight average molecular weight in a range of 100,000 to 500,000. Within the above range, graphitization may be facilitated when manufacturing the graphite sheet. In this case, the “weight average molecular weight” may be measured by gel chromatography (GPC) using polystyrene as a standard sample. The weight average molecular weight of the polyamic acid may be, for example, in a range of 150,000 to 500,000, for another example, in a range of 100,000 to 400,000, or for a further example, in a range of 250,000 to 400,000, but is not limited thereto.

As for the dianhydride monomer and the diamine monomer, various monomers commonly used in the field of polyimide film formation may be used. For example, the dianhydride monomer may be an aromatic dianhydride monomer, and the diamine monomer may be an aromatic diamine monomer. As for the dianhydride monomer, pyromellitic dianhydride, 3,3′,4,4′-biphenyltetracarboxylic dianhydride, 2,3,3′,4′-biphenyltetracarboxylic dianhydride, oxydiphthalic dianhydride, diphenylsulfone-3,4,3′,4′-tetracarboxylic dianhydride, bis(3,4-dicarboxyphenyl)sulfide dianhydride, 2,2-bis(3,4-dicarboxyphenyl)-1,1,1,3,3,3-hexafluoropropane dianhydride, 2,3,3′,4′-benzophenonetetracarboxylic dianhydride, 3,3′,4,4′-benzophenonetetracarboxylic dianhydride, bis(3,4-dicarboxyphenyl)methane dianhydride, 2,2-bis(3,4-dicarboxyphenyl)propane dianhydride, p-phenylenebis(trimellitic acid monoester anhydride), p-biphenylenebis(trimellitic acid monoester anhydride), m-terphenyl-3,4,3′,4′-tetracarboxylic dianhydride, p-terphenyl-3,4,3′,4′-tetracarboxylic acid dianhydride, 1,3-bis(3,4-dicarboxyphenoxy)benzene dianhydride, 1,4-bis(3,4-dicarboxyphenoxy)benzene dianhydride, 1,4-bis(3,4-dicarboxyphenoxy)biphenyl dianhydride, 2,2-bis[(3,4-dicarboxyphenoxy)phenyl]propane dianhydride, 2,3,6,7-naphthalenetetracarboxylic dianhydride, 1,4,5,8-naphthalenetetracarboxylic dianhydride, 4,4′-(2,2-hexafluoroisopropylidene)diphthalic dianhydride, or any combination thereof may be used, but is not limited thereto. As for the diamine monomer, diamine monomers containing one benzene ring (for example, 1,4-diaminobenzene, 1,3-diaminobenzene, 2,4-diaminotoluene, 2,6-diaminotoluene, 3,5-diaminobenzoic acid, and the like), diamine monomers containing two benzene rings (for example, diaminodiphenyl ethers, such as 4,4′-diaminodiphenyl ether, 3,4′-diaminodiphenyl ether, and the like, 4,4′-diaminodiphenylmethane, 3,3′-dimethyl-4,4′-diaminobiphenyl, 2,2′-dimethyl-4,4′-diaminobiphenyl, 2,2′-bis(trifluoromethyl)-4,4′-diaminobiphenyl, 3,3′-dimethyl-4,4′-diaminodiphenylmethane, 3,3′-dicarboxy-4,4′-diaminodiphenylmethane, 3,3′,5,5′-tetramethyl-4,4′-diaminodiphenylmethane, bis(4-aminophenyl)sulfide, 4,4′-diaminobenzanilide, 3,3′-dimethylbenzidine, 2,2′-dimethylbenzidine, 3,3′-dimethoxybenzidine, 2,2′-dimethoxybenzidine, 3,3′-diaminodiphenyl ether, 3,4′-diaminodiphenyl ether, 4,4′-diaminodiphenyl ether, 3,3′-diaminodiphenylsulfide, 3,4′-diaminodiphenylsulfide, 4,4′-diaminodiphenylsulfide, 3,3′-diaminodiphenylsulfone, 3,4′-diaminodiphenylsulfone, 4,4′-diaminodiphenylsulfone, 3,3′-diaminobenzophenone, 4,4′-diaminobenzophenone, 3,3′-diamino-4,4′-dichlorobenzophenone, 3,3′-diamino-4,4′-dimethoxybenzophenone, 3,3′-diaminodiphenylmethane, 3,4′-diaminodiphenylmethane, 4,4′-diaminodiphenylmethane, 2,2-bis(3-aminophenyl)propane, 2,2-bis(4-aminophenyl)propane, 2,2-bis(3-aminophenyl)-1,1,1,3,3,3-hexafluoropropane, 2,2-bis(4-aminophenyl)-1,1,1,3,3,3-hexafluoropropane, 3,3′-diaminodiphenyl sulfoxide, 3,4′-diaminodiphenyl sulfoxide, 4,4′-diaminodiphenyl sulfoxide, and the like), diamine containing three benzene rings monomers (for example, 1,3-bis(3-aminophenyl)benzene, 1,3-bis(4-aminophenyl)benzene, 1,4-bis(3-aminophenyl)benzene, 1,4-bis(4-aminophenyl)benzene, 1,3-bis(4-aminophenoxy)benzene, 1,4-bis(3-aminophenoxy)benzene, 1,3-bis(3-aminophenoxy)-4-trifluoromethylbenzene, 3,3′-diamino-4-(4-phenyl)phenoxybenzophenone, 3,3′-diamino-4,4′-di(4-phenylphenoxy)benzophenone, 1,3-bis(3-aminophenylsulfide)benzene, 1,3-bis(4-aminophenylsulfide)benzene, 1,4-bis(4-aminophenylsulfide)benzene, 1,3-bis(3-aminophenylsulfone)benzene, 1,3-bis(4-aminophenylsulfone)benzene, 1,4-bis(4-aminophenylsulfone)benzene, 1,3-bis[2-(4-aminophenyl)isopropyl]benzene, 1,4-bis[2-(3-aminophenyl)isopropyl]benzene, 1,4-bis[2-(4-aminophenyl)isopropyl]benzene, and the like), diamine monomers containing four benzene rings (for example, 3,3′-bis(3-aminophenoxy)biphenyl, 3,3′-bis(4-aminophenoxy)biphenyl, 4,4′-bis(3-aminophenoxy)biphenyl, 4,4′-bis(4-aminophenoxy) biphenyl, bis[3-(3-aminophenoxy)phenyl]ether, bis[3-(4-aminophenoxy)phenyl]ether, bis[4-(3-aminophenoxy)phenyl]ether, bis[4-(4-aminophenoxy)phenyl]ether, bis[3-(3-aminophenoxy)phenyl]ketone, bis[3-(4-aminophenoxy)phenyl]ketone, bis[4-(3-aminophenoxy)phenyl]ketone, bis[4-(4-aminophenoxy)phenyl]ketone, bis[3-(3-aminophenoxy))phenyl]sulfide, bis[3-(4-aminophenoxy)phenyl]sulfide, bis[4-(3-aminophenoxy)phenyl]sulfide, bis[4-(4-aminophenoxy)phenyl]sulfide, bis[3-(3-aminophenoxy)phenyl]sulfone, bis[3-(4-aminophenoxy)phenyl]sulfone, bis[4-(3-aminophenoxy)phenyl]sulfone, bis[4-(4-aminophenoxy)phenyl]sulfone, bis[3-(3-aminophenoxy)phenyl]methane, bis[3-(4-aminophenoxy)phenyl]methane, bis[4-(3-aminophenoxy)phenyl]methane, bis[4-(4-aminophenoxy)phenyl]methane, 2,2-bis[3-(3-aminophenoxy)phenyl]propane, 2,2-bis[3-(4-aminophenoxy)phenyl]propane, 2,2-bis[4-(3-aminophenoxy)phenyl]propane, 2,2-bis[4-(4-aminophenoxy)phenyl]propane, 2,2-bis[3-(3-aminophenoxy)phenyl]-1,1,1,3,3,3-hexafluoropropane, 2,2-bis[3-(4-aminophenoxy)phenyl]-1,1,1,3,3,3-hexafluoropropane, 2,2-bis[4-(3-aminophenoxy)phenyl]-1,1,1,3,3,3-hexafluoropropane, 2,2-bis[4-(4-aminophenoxy)phenyl]-1,1,1,3,3,3-hexafluoropropane, and the like), or any combination thereof may be used, but is not limited thereto.

In particular, pyromellitic dianhydride, 3,3′,4,4′-biphenyltetracarboxylic dianhydride, 2,3,3′,4-biphenyltetracarboxylic dianhydride, oxydiphthalic anhydride, bis(3,4-dicarboxyphenyl)sulfone dianhydride, 3,3′,4,4′-benzophenonetetracarboxylic acid dianhydride, or any combination thereof may be used as the dianhydride monomer. In addition, 4,4′-oxydianiline, 3,4′-oxydianiline, p-phenylenediamine, m-phenylenediamine, 4,4′-methylenedianiline, 3,3′-methylenedianiline, or any combination thereof may be used as the diamine monomer.

The polyimide film may have a thickness in a range of 25 to 500 μm. The thickness of the polyimide film may be, for example, in a range of 25 to 125 μm, or for another example, in a range of 40 to 500 μm, but is not limited thereto.

The polyimide film may be formed by various methods commonly used in the field of polyimide film formation. For example, the polyimide film may be formed by polymerizing one or more types of dianhydride monomers and one or more types of diamine monomers in a solvent to prepare a polyamic acid solution and then adding an imidization catalyst, a dehydrating agent, and optionally, a sublimable inorganic filler, a solvent, and the like to the polyamic acid solution to prepare a composition for polyimide film, followed by performing film formation using the composition, but is not limited thereto.

The imidization process of the polyamic acid solution may be performed through a known imidization method, including thermal imidization, chemical imidization, or a combination of thermal imidization and chemical imidization methods.

The entire sublimable inorganic filler contained in the polyimide film may have a median particle diameter (D₅₀) in a range of 0.1 to 5.0 μm. In addition, the entire sublimable inorganic filler may be contained in an amount in a range of 0.07% to 0.4% by weight with respect to the total weight of the polyimide film.

The sublimable inorganic filler may be sublimated during the carbonization and/or graphitization of the polyimide film, thereby inducing predetermined foaming. Such foaming enables a high-quality graphite sheet to be obtained by facilitating the exhaustion of sublimation gas generated during the carbonization and/or graphitization. In addition, predetermined voids formed according to the foaming may improve the flex resistance (“flexibility”) of the graphite sheet.

However, excessive foaming and a large number of voids resulting therefrom may significantly deteriorate the thermal conductivity and the mechanical properties of the graphite sheet and may cause defects on the surface of the graphite sheet. As a result, careful selection is required for the type, amount, and particle size of the sublimable inorganic filler.

The “median particle diameter (D₅₀)” may be measured using a laser diffraction particle size analyzer (SALD-2201, Shimadzu) after dispersing the sublimable inorganic filler through ultrasonic dispersion in a dimethylformamide solvent at a temperature of 25° C. for 5 minutes.

The entire sublimable inorganic filler in the polyimide film may have a median particle diameter (D₅₀), for example, in a range of 0.5 to 4.0 μm, for another example, in a range of 0.1 to 2.5 μm, for a further example, in a range of 1.5 to 5.0 μm, or for yet another example, in a range of 1.5 to 2.5 μm, but is not limited thereto. The entire sublimable inorganic filler in the polyimide film may be contained in an amount, for example, in a range of 0.07% to 0.35% by weight, for another example, in a range of 0.1% to 0.3% by weight, or for a further example, in a range of 0.15% to 0.3% by weight, with respect to the total weight of the polyimide film, but is not limited thereto.

The sublimable inorganic filler may include a first sublimable inorganic filler having a median particle diameter (D₅₀) in a range of 0.1 to 2.0 μm and a second sublimable inorganic filler having a median particle diameter (D₅₀) in a range of greater than 2.0 to 5.0 μm.

Each amount of the first sublimable inorganic filler and the second sublimable inorganic filler of the sublimable inorganic filler is not particularly limited, but for example, with respect to the total weight of the sublimable inorganic filler, the first sublimable inorganic filler may be included in an amount in a range of 90% to 10% by weight of, and the second sublimable inorganic filler may be contained in an amount in a range of 10% to 90% by weight. For example, with respect to the total weight of the sublimable inorganic filler, the first sublimable inorganic filler may be included in an amount, for example, in a range of 15% to 85% by weight, for another example, in a range of 20% to 80% by weight, for a further example, in a range of 30% to 85% by weight, or for yet another example, in a range of 50% to 80% by weight. In addition, the second sublimable inorganic filler may be included in an amount, for example, in a range of 85% to 15% by weight, for another example, in a range of 80% to 20% by weight, for a further example, in a range of 70% to 20% by weight, or for yet another example, in a range of 50% to 20% by weight. However, the present disclosure is not limited thereto.

Examples of the sublimable inorganic filler may include calcium carbonate, dicalcium phosphate, barium sulfate, and the like, but are not limited thereto.

The solvent is not particularly limited as long as it is capable of dissolving the polyamic acid. For example, the solvent may include an aprotic polar solvent.

In particular, sulfoxide-based solvents, such as dimethyl sulfoxide and diethyl sulfoxide, formamide-based solvents, such as N,N-dimethylformamide and N,N-diethylformamide, acetamide-based solvents, such as N,N-dimethylacetamide and N,N-diethylacetamide, pyrrolidone-based solvents, such as N-methyl-2-pyrrolidone and N-vinyl-2-pyrrolidone, phenol-based solvents, such as phenol, o-, m-, or p-cresol, xylenol, halogenated phenol, and catechol, aprotic polar solvents, such as hexamethylphosphoramide and γ-butyrolactone, and the like may be used alone or in a combination of two or more, but the present disclosure is not limited thereto.

As for the dehydrating agent, acetic anhydride, propionic anhydride, butyric anhydride, benzoic anhydride, and the like may be used alone or in a combination of two or more, but the present disclosure is not limited thereto.

The film formation may be performed by applying the polyamic acid solution in a film form on a substrate, preparing a gel film through heating and drying at a temperature in a range of 30° C. to 200° C. for 15 seconds to 30 minutes, and then thermally treating the gel film, from which the substrate is removed, at a temperature in a range of 250° C. to 600° C. for 15 seconds to 30 minutes, but the present disclosure is not limited thereto.

In one embodiment, the polyimide film may have an elongation of 120% or more a strength of 210 MPa or more, a true density of 1.35 g/cm³ or more, and a residual amount of 56% by weight or more when being thermally decomposed at a temperature of 1000° C.

The polyimide film may have an elongation of 135% or less, a strength of 230 MPa or less, and a true density of 1.55 g/cm³ or less.

With the increasing proportion of the plasticizer having a relatively high molecular weight in the total amount of the plasticizers (amount of the first plasticizer+amount of the second plasticizer), a tendency that the elongation and the strength slightly decrease is shown.

In addition, with the increasing proportion of the plasticizer having a relatively high molecular weight in the total amount of the plasticizers (amount of the first plasticizer+amount of the second plasticizer), a tendency that the residual amount increases when being thermally decomposed at a temperature of 1000° C. is shown.

When the true density of the polyimide film is low, rearrangement of carbon is unfavorable during the graphitization process, thus lowering the thermal conductivity. When the true density of the polyimide film is excessively high, the appearance of the graphite sheet may be poor due to excessive compactness.

The “true density” means a density excluding both closed and open pores and is different from the apparent density including closed pores despite excluding open pores.

The true density of the polyimide film is controllable in various ways. For example, the true density of the polyimide film may be controlled by a method of adjusting the molecular weight of polyamic acid, which is a precursor of the polyimide film, adding a solvent to the polyamic acid to control the viscosity, or controlling the type, particle size, amount, and the like of the filler contained in the polyimide film. However, the present disclosure is not limited thereto.

In one embodiment, the polyimide film may be used for manufacturing a graphite sheet.

When manufacturing the graphite sheet using the polyimide film, a decrease in thermal diffusivity, a mass loss rate, and a foaming rate are controllable, so a graphite sheet having excellent characteristics may be manufactured.

A method of manufacturing a graphite sheet, according to another aspect of the present disclosure, includes subjecting the polyimide film to carbonization, graphitization, or both of the carbonization and graphitization.

The carbonization is a process of thermally decomposing the polymer chains of the polyimide film to manufacture a preliminary graphite sheet containing an amorphous carbon body, a non-crystalline carbon body, and/or a formless carbon body. For example, the carbonization may include raising a temperature of the polyimide film from room temperature to a temperature in a range of 1,000° C. to 1,500° C., which is the highest temperature, under an inert gas atmosphere or reduced pressure for 10 hours to 30 hours and maintaining the same temperature, but is not limited thereto. For high orientation of carbon, a hot press and the like may be selectively used during the carbonization to pressurize the polyimide film. In this case, the pressure may be, for example, 5 kg/cm² or more, for another example, 15 kg/cm² or more, or for a further example, 25 kg/cm² or more, but is not limited thereto.

The graphitization is a process of rearranging the carbon of the amorphous carbon body, non-crystalline carbon body, and/or formless carbon body to manufacture the graphite sheet. For example, the graphitization may include selectively raising a temperature of the preliminary graphite sheet from room temperature to a temperature in a range of 2,500° C. to 3,000° C., which is the highest temperature, under an inert gas atmosphere for 2 hours to 30 hours and maintaining the same temperature, but is not limited thereto. For high orientation of carbon, a hot press and the like may be selectively used during the graphitization to pressurize the preliminary graphite sheet. In this case, the pressure may be, for example, 100 kg/cm² or more, for another example, 200 kg/cm² or more, or for a further example, 300 kg/cm² or more, but is not limited thereto.

A graphite sheet, according to a further aspect of the present disclosure, may be manufactured by the method described above, and may have a thermal diffusivity of 720 mm²/s or more and a foaming thickness of 85 μm or smaller.

The thermal diffusivity may be 780 mm²/s or less, and the foaming thickness may be 60 m or larger.

Excessive foaming during the carbonization and graphitization processes is undesirable because damage to the internal structure of the graphite sheet may occur, thus deteriorating the thermal conductivity of the graphite sheet, and the number of bright spots, which are signs of foaming, may be increased on the surface of the graphite sheet.

### MODE FOR INVENTION

Hereinafter, the present disclosure will be described in further detail with reference to embodiments. However, these embodiments are presented as preferred examples of the present disclosure and cannot be construed as limiting the scope of the present disclosure in any sense.

### Preparation Example 1 (Formation of Polyimide Film)

205.0 g of dimethylformamide as a solvent was added to a reactor, followed by setting a temperature to 20° C. Then, 21.5 g of 4,4′-oxydianiline (ODA) as a diamine monomer was added to the reactor, and 23.4 g of pyromellitic dianhydride (PMDA) as a dianhydride monomer was subsequently added to prepare a polyamic acid solution having a viscosity of 230,000 cP.

Next, 39.5 g of acetic anhydride as a dehydrating agent, 4.8 g of 0-picoline as an imidizing agent, 0.12 g of dicalcium phosphate (median particle diameter (D₅₀): 2.5 μm) as a sublimable inorganic filler, and 30.4 g of dimethyl formamide were mixed in the prepared polyamic acid solution.

In addition, a polyimide film precursor solution was prepared by adding appropriate amounts of a first plasticizer (triphenyl phosphate, TPP) and a second plasticizer (tricresyl phosphate, TCP).

The prepared polyimide film precursor solution was cast on a SUS plate (100SA, Sandvik) using a doctor blade at a thickness of 500 μm and then dried at a temperature in a range of 100° C. to 200° C. to form a self-supporting gel film.

Subsequently, the gel film was peeled off from the SUS plate, fixed on a pin frame, and transferred to a high-temperature tenter. The film was heated from 200° C. to 700° C. in the high-temperature tenter, cooled at 25° C., and separated from the pin frame to obtain a polyimide film.

### Preparation Example 2 (Manufacturing of Graphite Sheet)

A temperature of the polyimide film formed in Preparation Example 1 was raised to 1,210° C. at a rate of 3.3° C./min under nitrogen gas using an electric furnace capable of carbonization. Then, the raised temperature of 1,210° C. was maintained for about 2 hours (carbonization).

Next, a first calcination step was performed by raising the temperature from 1,210° C. to 2,200° C. at a heating rate of 2.5° C./min under argon gas using an electric furnace capable of graphitization.

After reaching a temperature of 2,200° C., a second calcination step was performed by changing the heating rate to a heating rate of 1.25° C./min to continuously raise the temperature to 2,500° C.

After reaching a temperature of 2,500° C., a third calcination step was performed by changing the heating rate to a heating rate of 10° C./min to continuously raise the temperature to 2,800° C. Then, after standing at 2,800° C. for several minutes, graphitization was completed to manufacture a graphite sheet.

Finally, the graphite sheet was cooled at a rate of 10° C./min.

### Example 1

When forming a polyimide film according to Preparation Example 1, a first plasticizer and a second plasticizer were added in amounts of 0.47% by weight and 0.08% by weight, respectively, with respect to the total amount of an imidization catalyst mixed in the polyamic acid solution (assuming that the total amount of the imidization catalyst was 100% by weight). Then, a graphite sheet was manufactured according to Preparation Example 2.

### Example 2

A graphite sheet was manufactured in the same manner as in Example 1, except that the first plasticizer and the second plasticizer were added in amounts of 0.39% by weight and 0.17% by weight, respectively, with respect to the total amount of the imidization catalyst mixed in the polyamic acid solution.

### Example 3

A graphite sheet was manufactured in the same manner, except that the first plasticizer and the second plasticizer were added in amounts of 0.28% by weight and 0.28% by weight, respectively, with respect to the total amount of the imidization catalyst mixed in the polyamic acid solution.

### Example 4

A graphite sheet was manufactured in the same manner as in Example 1, except that the first plasticizer and the second plasticizer were added in amounts of 0.17% by weight and 0.39% by weight, respectively, with respect to the total amount of the imidization catalyst mixed in the polyamic acid solution.

### Comparative Example 1

A graphite sheet was manufactured in the same manner as in Example 1, except that the first plasticizer and the second plasticizer were not added.

### Comparative Example 2

A graphite sheet was manufactured in the same manner as in Example 1, except that the first plasticizer was not added, and only the second plasticizer was added in an amount of 0.56% by weight, with respect to the total amount of the imidization catalyst mixed in the polyamic acid solution.

### Comparative Example 3

A graphite sheet was manufactured in the same manner as in Example 1, except that the second plasticizer was not added, and only the first plasticizer was added in an amount of 0.56% by weight, with respect to the total amount of the imidization catalyst mixed in the polyamic acid solution.

Each amount of the first and second plasticizers of Examples 1 to 4 and Comparative Examples 1 to 3 are shown in Table 1 below.

TABLE 1

| | Plasticizer | |
|---|---|---|
| | First plasticizer (TPP) | Second plasticizer (TCP) |
| Example 1 | 0.47 | 0.08 |
| Example 2 | 0.39 | 0.17 |
| Example 3 | 0.28 | 0.28 |
| Example 4 | 0.17 | 0.39 |
| Comparative Example 1 | 0 | 0 |
| Comparative Example 2 | 0 | 0.56 |
| Comparative Example 3 | 0.56 | 0 |

### Experimental Example 1

The elongation and strength of the polyimide films of Examples 1 to 4 and Comparative Examples 1 to 3, formed according to Preparation Example 1, were measured.

The elongation and strength were measured using Autograph universal testing machines (SHIMADZU, AG-IS) in accordance with ASTM D₈₈₂.

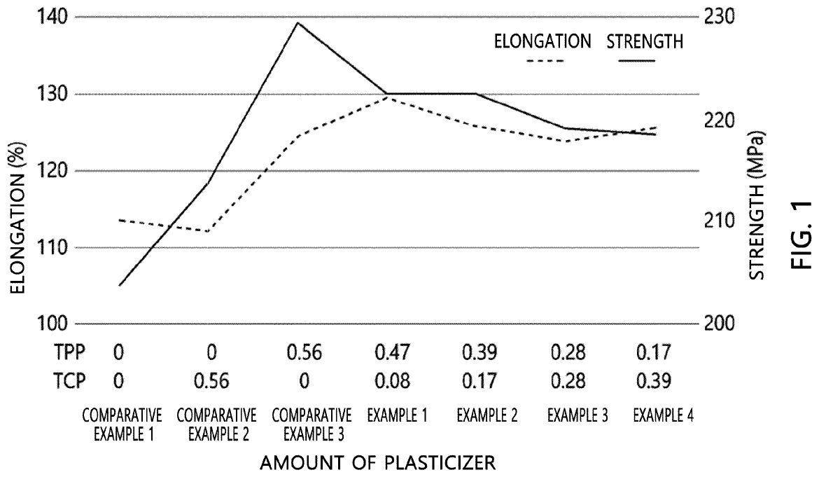

As shown in FIG. 1, both the elongation and strength of the polyimide films of Examples 1 to 4, in which the first plasticizer and the second plasticizer were mixed, were increased, compared to those of the polyimide film of Comparative Example 1 not involving the first plasticizer and the second plasticizer.

In addition, in the case of each polyimide film of Comparative Examples 2 and 3 containing only either the first plasticizer or the second plasticizer, both the elongation and strength also tended to be increased, compared to the case of the polyimide film of Comparative Example 1. In the case of the polyimide films of Examples 1 to 4 in which the first plasticizer and the second plasticizer were mixed, both the elongation and strength were increased, compared to the case of the polyimide film of Comparative Example 2 containing only the first plasticizer. However, compared to the case of the polyimide film of Comparative Example 3 containing only the second plasticizer, the strength was slightly low, and the elongation was similar or at a higher level.

Specifically, in the case of Examples 1 to 4, the polyimide films were measured to have a strength in a range of 215 to 225 MPa and an elongation in a range of 1²⁰% to 135%.

With the increasing proportion of the second plasticizer (TCP) in the total amount of the plasticizers (amount of the first plasticizer+amount of the second plasticizer), a tendency that the elongation and strength of the polyimide film partially decreased was shown, although the change thereof was not significant.

### Experimental Example 2

The true density of the polyimide films of Examples 1 to 4 and Comparative Examples 1 to 3, formed according to Preparation Example 1, was measured.

The true density measurement was performed on a specimen cut from the formed polyimide film to a size of 15 mm×300 mm (width×length) with helium gas at room temperature using a pycnometer (AccuPyc 1340, Micromeritics).

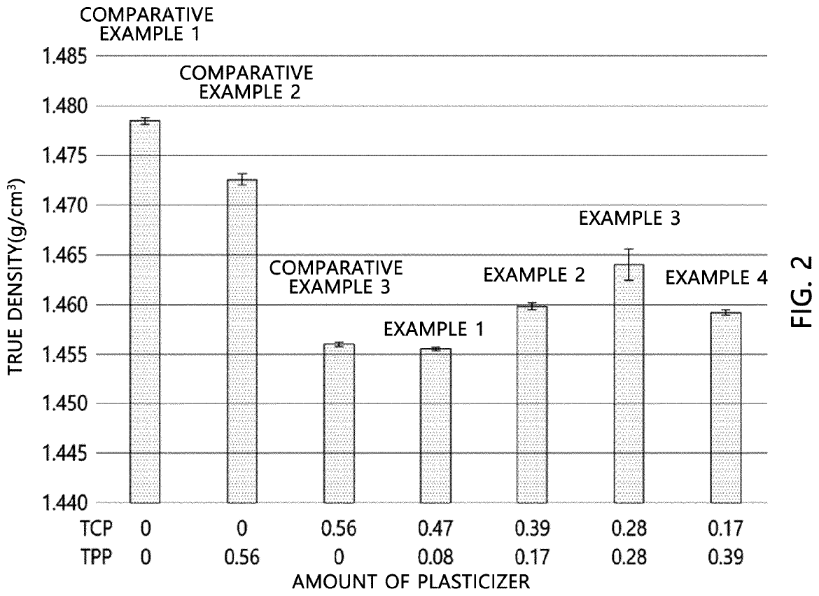

As shown in FIG. 2, the polyimide films of Examples 1 to 4 were measured to have a true density in a range of 1.45 to 1.47 g/cm³.

With the increasing proportion of the second plasticizer (TCP) in the total amount of the plasticizers (amount of the first plasticizer+amount of the second plasticizer), a tendency that the true density of the polyimide film gradually increased and then decreased was shown.

On the contrary, the true density of the polyimide films of Comparative Examples 1 and 2 was excessively higher than that of the polyimide films of Examples 1 to 4, resulting in a problem of deterioration in the appearance of the manufactured graphite sheet.

### Experimental Example 3

The thermal decomposition characteristics of the polyimide films of Examples 1 to 4 and Comparative Example 1, formed according to Preparation Example 1, were measured.

The thermal decomposition characteristics were measured by raising a temperature to 1000° C. at a rate of 10° C./min through thermogravimetric analysis (TA Instruments, TGA5500).

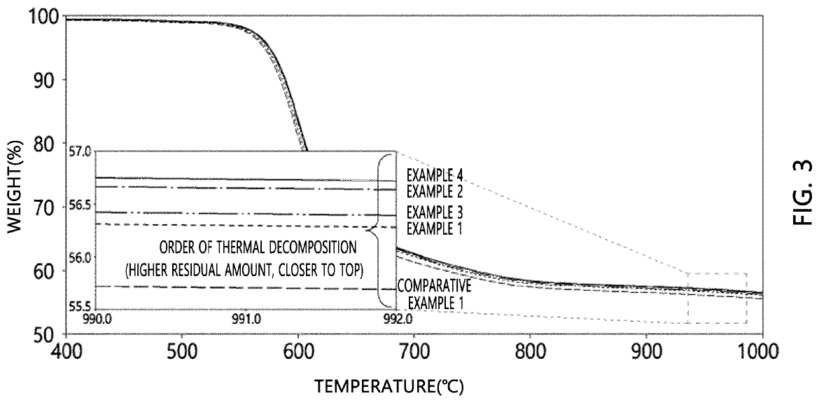

As shown in FIG. 3, the residual amount of all the polyimide films of Examples 1 to 4, in which the first plasticizer and the second plasticizer were mixed, was increased when thermally decomposed at a temperature of 1000° C., compared to that of the polyimide film of Comparative Example 1 not involving the first plasticizer and the second plasticizer.

In the case of Examples 1 to 4, the residual amount was measured to be 56% by weight or more when thermally decomposed at a temperature of 1000° C.

With the increasing proportion of the second plasticizer (TCP) in the total amount of the plasticizers (amount of the first plasticizer+amount of the second plasticizer), a tendency that the residual amount slightly increased was shown.

### Experimental Example 4

The thermal diffusivity and foaming thickness of the graphite sheets of Examples 1 to 4 and Comparative Examples 2 and 3, manufactured according to Preparation Example 2, were measured.

In the case of Examples 1 to 4, the manufactured graphite sheets were measured to have a thermal diffusivity in a range of 720 to 760 mm²/s and a foaming thickness in a range of 70 to 85 μm.

The thermal diffusivity was measured by a laser flash method using a measuring device (Netsch, LFA 467) for in-plane thermal diffusivity measurement. In addition, the foaming thickness was measured by a digital micrometer (Standard-type, Mitutoyo).

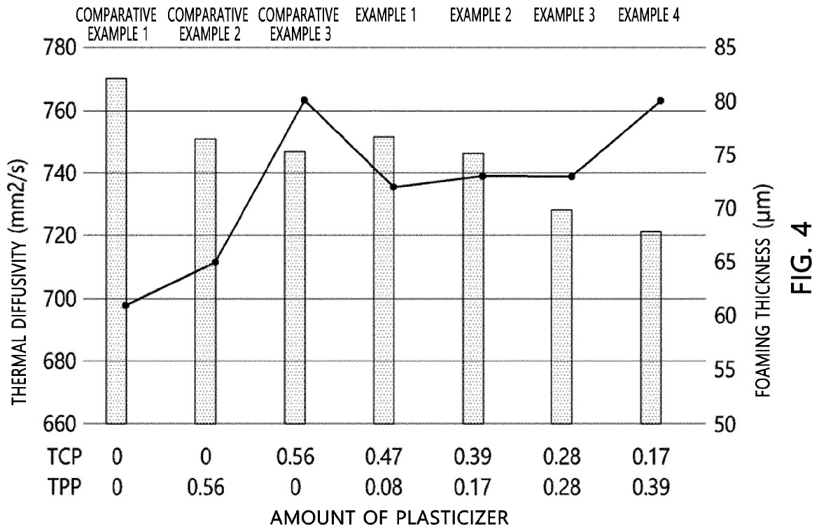

As shown in FIG. 4, with the increasing proportion of the second plasticizer (TCP) in the total amount of the plasticizers (amount of the first plasticizer+amount of the second plasticizer), a tendency that the thermal diffusivity decreased was shown.

On the contrary, with the increasing proportion of the second plasticizer (TCP) in the total amount of the plasticizers (amount of the first plasticizer+amount of the second plasticizer), a tendency that the foaming thickness increased was shown.

In addition, in the case of Comparative Example 3 containing only the second plasticizer, multiple bright spots were generated on the manufactured graphite sheet compared to the case of Examples 1 to 4, thereby deteriorating the surface quality of the graphite sheet.

The embodiments of the manufacturing method of the present disclosure are only preferred embodiments that allow those skilled in the art to easily practice the present disclosure in the technical field to which the present disclosure belongs, and is not limited to the embodiments described above. Accordingly, the scope of the present disclosure is not limited. Thus, the true technical protection scope of the present disclosure should be defined by the technical spirit of the appended claims. In addition, those skilled in the art will appreciate that various modifications, alternatives, and substitutions are possible, without departing from the scope and spirit of the present disclosure as disclosed in the accompanying claims. Furthermore, it is apparent that modifications capable of being easily embodied by those skilled in the art are included within the scope of the present disclosure.

### INDUSTRIAL APPLICABILITY

The present disclosure can provide a polyimide film having a low mass rate during carbonization and graphitization, in which a thermal diffusivity is kept from decreasing, a method of manufacturing a graphite sheet from the polyimide film, and a graphite sheet having an excellent appearance manufactured thereby.

1. A polyimide film comprising a first plasticizer and a second plasticizer, wherein each of the first plasticizer and the second plasticizer has a molecular weight of 700 g/mol or less.

2. The polyimide film of claim 1, wherein a difference in molecular weight between the first plasticizer and the second plasticizer is 150 g/mol or less.

3. The polyimide film of claim 1, wherein the first and second plasticizers are contained in an amount of 1.65% by weight or less with respect to the total amount of an imidization catalyst contained in the polyimide film.

4. The polyimide film of claim 1, wherein a weight ratio of the first plasticizer to the second plasticizer is in a range of 1:9 to 9:1.

5. The polyimide film of claim 1, wherein each of the first plasticizer and the second plasticizer is a phosphorus-based plasticizer.

6. The polyimide film of claim 5, wherein the first plasticizer or the second plasticizer is any one selected from the group consisting of triphenyl phosphate, tricresyl phosphate, triphenylphosphine, resorcinol bis(diphenyl phosphate), and bisphenol A bis(diphenyl phosphate).

7. The polyimide film of claim 1, wherein the polyimide film is formed from: a dianhydride monomer comprising pyromellitic dianhydride, 3,3′,4,4′-biphenyltetracarboxylic dianhydride, 2,3,3′,4-biphenyltetracarboxylic dianhydride, oxydiphthalic anhydride, bis(3,4-dicarboxyphenyl)sulfone dianhydride, 3,3′,4,4′-benzophenonetetracarboxylic acid dianhydride, or any combination thereof; and
a diamine monomer comprising 4,4′-oxydianiline, 3,4′-oxydianiline, p-phenylenediamine, m-phenylenediamine, 4,4′-methylenedianiline, 3,3′-methylenedianiline, or any combination thereof.

8. The polyimide film of claim 1, wherein the polyimide film has an elongation of 120% or more, a strength of 210 MPa or more, a true density of 1.35 g/cm³ or higher, and a residual amount of 56% by weight or more when being thermally decomposed at a temperature of 1000° C.

9. The polyimide film of claim 1, wherein the polyimide film is used to manufacture a graphite sheet.

10. A method of manufacturing a graphite sheet, the method comprising subjecting the polyimide film of claim 1 to carbonization, graphitization, or both of the carbonization and graphitization.

11. A graphite sheet manufactured by the method of claim 10, the graphite sheet having a thermal diffusivity of 720 mm²/s or more and a foaming thickness of 85 μm or smaller.
